(19) United States
(12) Patent Application Publication
(10) Pub. No.: US 2003/0071755 A1
(43) Pub. Date: Apr. 17, 2003

(54) Helix antenna with a cap of high dielectric coefficient

(75) Inventors: Jammy Lin, Tuu-Cheng City (TW); Ping Kun Wu, Tao-Yuan City (TW)

Correspondence Address: DOUGHERTY & TROXELL, SUITE 1404, 5205 LEESBURG PIKE, FALLS CHURCH, VA, 22041, US

(73) Assignee: Auden Techno Corp.

(21) Appl. No.: 09/975,157

(22) Filed: Oct. 12, 2001

(51) Int. Cl. H01Q 1/24; H01Q 1/36

(52) U.S. Cl. 343/702; 343/895

(57) ABSTRACT

A helix antenna with a cap of high dielectric coefficient, which includes the cap to be installed on the end portion of an insulating sleeve, a coil is positioned in the cap and the insulating sleeve. The cap is made of high dielectric coefficient material with an internal extension post integrally shaped therein in matching with the coil by diameter in order that the coil is fitted over the internal extension post, a high dielectric coefficient thus is obtained inside the coil to thereby decrease wavelength correspondingly. Verticality of the coil can be corrected to improve electric stability and make the overall length of the helix antenna be shortened effectively. Thus an improved helix antenna can be formed.

### BACKGROUND OF THE INVENTION

1. Field of the Invention

The invention is related to a helix antenna with a cap of high dielectric coefficient, and especially to such an antenna of which the antenna length is shortened and the electric stability is increased effectively by improvement of the cap structure.

2. Description of the Prior Art

A helix coil formed by winding a metallic wire is the main element of an antenna for transmitting and receiving signals. The structure of such helix antenna affects the function of the whole antenna in every aspect. The helix antenna as disclosed in British patent no. 2,206,243 of which the diameter of wire of the coil, the material of the coil, the core diameter, the pitch and the overall length of the helix coil etc. all affect its proper and set function. At the same time, either of the conventional helix antenna or of modern microstrip antennas gradually popularized in use nowadays, the pre-set lengths are all given in pursuance of wavelength λ.

To take a mobile phone as an example, the coil of the equipment using this kind of helix antenna in general is inserted in the inner bore of an insulating sleeve, and the coil is mounted in the inner bore of the insulating sleeve in an axially elastically compressed state. Because of the feature of the coil, this kind of combination structure will induce an unpredictable effect on the pitch and overall length of the helix coil. That is to say, the coil may have the problem of changing of its pitch, or the overall length may be varied from the original pre-set one after assembling. This is especially subjected to causing a phenomenon of uneven qualities of antennas during mass production for the abovementioned combination structure of the conventional coils.

Referring to FIG. 1, it is a sectional view showing the structure of this kind of conventional helix antenna of which an insulating sleeve 10, a cap 11 and a coil 12 are included therein. The coil 12 can be provided in an inner bore 13 opened upwardly of the insulating sleeve 10 and fitted in the cap 11. Then a working process such as high frequency welding is applied to make one end of the coil 12 be compressed and abutted upon an inner top surface 14 of the cap 11 and make the other end be abutted against an inner bottom surface 15 of the inner bore 13. In this kind of conventional helix antenna structure, the overall upright length will be affected obviously after the coil 12 is mounted and positioned due to the flexible structure of the coil itself and thus will make the electric stability undesired. By the fact that the inside portion of the coil 12 is full of air, and its dielectric coefficient is smaller, and according to the wavelength formula:

$$λ = \frac{c}{f \sqrt{δ}}$$

λ in the above formula is wavelength, “c” is capacity, “f” is frequency and δ is a dielectric coefficient; and since the dielectric coefficient of the air is 1, if δ is relatively small, λ will become larger; hence the overall antenna length needs to be lengthened correspondingly and hard to be shortened. But for modern communication equipments such as a mobile phone, miniaturization is the main stream in the trend of designing, coils to be set with longer lengths to adapt to wavelengths are hard to meet the market requirements.

### SUMMARY OF THE INVENTION

The object of the present invention is to provide a helix antenna with a cap of high dielectric coefficient of which the antenna length can be shortened and the electric stability can be increased effectively through improvement of the cap structure.

To achieve the abovementioned object, in shaping the cap of the helix coil of the present invention, an internal extension post of which the diameter matches the core diameter is extended from the inner top surface of the cap. The coil can be fitted over the internal extension post, so that the inside of the coil is fully filled with the internal extension post. On the one hand, the coil is positioned and thus is endued with a preferable verticality and a stable electric feature; on the other hand, based on the abovementioned wavelength formula, because the dielectric coefficient of the internal extension post is increased to render the wavelength (λ) decreased relatively, so that the antenna length can be shortened effectively.

The present invention will be apparent in its novelty and other features after reading the detailed description of the preferred embodiment thereof in reference to the accompanying drawings.

### BRIEF DESCRIPTION OF THE DRAWINGS

FIG. 1 is a sectional view showing the structure of a conventional helix antenna;

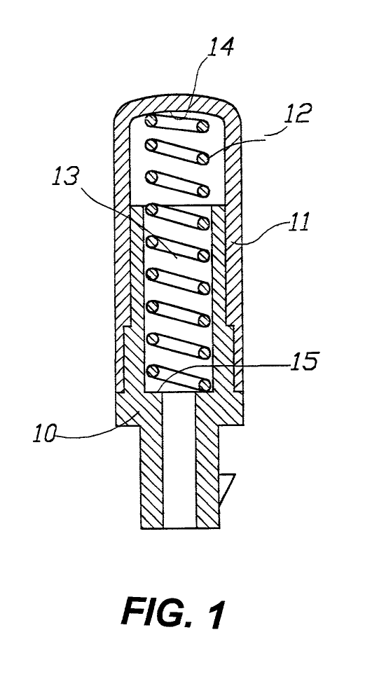

FIG. 2 is a sectional view showing the assembled state of a cap with a coil of the preferred embodiment of the present invention;

FIG. 3 is a sectional view showing the structure of an insulating sleeve mounted with the elements of FIG. 2.

### DETAILED DESCRIPTION OF THE PREFERRED EMBODIMENT

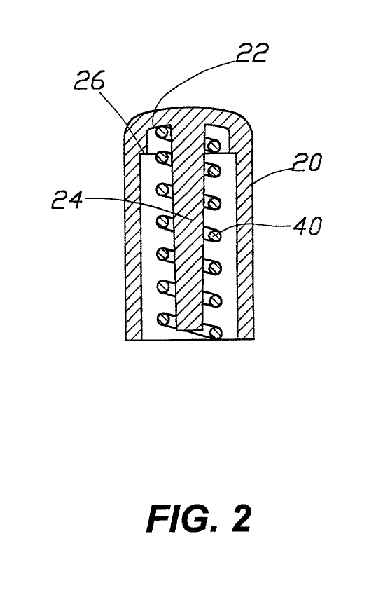

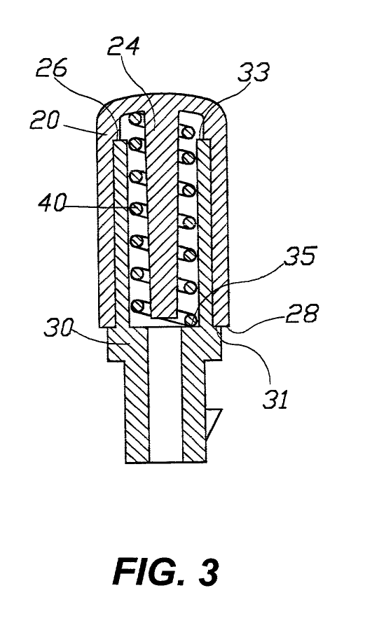

Referring to FIG. 2 and FIG. 3, the helix antenna of the present invention is also comprised of the following elements: a cap 20, an insulating sleeve 30 used for connecting with the cap 20, and an inside coil 40. By the improved designing on the structure of the cap 20 in the present invention, the longitudinal length of the cap 20 and the coil 40 are both decreased and the overall length of the helix coil is shortened accordingly.

The prime feature of the present invention is to provide an internal extension post 24 on an inner top surface 22 of the cap 20 close to the center position of the latter, and the internal extension post 24 can be fitted over by the coil 40. Hence the cross section of the internal extension post 24 is preferably to match the size of the core diameter of and the shape of the helix coil 40, and then both can be connected with each other in proper tightness.

In the embodiment as shown in the drawing, an inner stepped portion 26 can be provided on the cap 20, and an outer stepped portion 31 can be provided on the insulating sleeve 30. The lower end face 28 of the cap 20 and the upper end face 33 of an insulating sleeve 30 get close to each other and are positioned respectively at the outer stepped portion 31 and the inner stepped portion 26, thereby the inside coil 40 can be mounted inside the helix antenna between the inner top surface 22 of the cap 20 and the inner stepped surface 35 of the insulating sleeve 30 with a set pitch and overall length.

It can be seen from the abovementioned structure, the coil 40 set with a desired diameter of wire, core diameter, pitch and overall length is sustained by an internal extension post 24 during the assembling process, rather than is assembled inside the cap and the insulating sleeve in natural non-sustaining state. Hence the assembly process during the manufacturing procedure in a factory will not affect the pitch and the overall length of the coil obtained by maintaining its verticality. Thereby, a more stable and reliable electric feature can be obtained.

But the most important advantage is, by virtue that the empty inside of a coil 40 is filled up with an internal extension post 24, that is, the original dielectric coefficient when the interior is full with air has been changed. Presuming that the cap 20 and the internal extension post 24 therein is integrally shaped of plastic material, the dielectric coefficient (δ) of this kind of plastic material is around 2.2 in general. According to the previously mentioned wavelength formula:

When the coil 40 is not sustained by any other member and the inside thereof is full of air (dielectric coefficient is 1):

$$λ = \frac{c}{f \sqrt{δ}} = \frac{c}{f}$$

But when the coil 40 with the cap 20 is improved to have the structure mentioned above:

$${λ}^{′} = \frac{c}{f \sqrt{δ}} = \frac{c}{f \sqrt{2.2}} = \frac{c}{1.483 f}$$

That is to say, by using equivalent capacity (c) and identical frequency (f), the wavelength of the present invention (λ′)=0.674 λ. Namely, when using the material with a dielectric coefficient 2.2 for shaping the cap 20 and the internal extension post 24 therein for the entire of the cap 20 and coil 40, the overall length of the cap 20 and the coil 40 can be shortened by ⅓. Not only the consumed material can be saved efficiently, but also the overall longitudinal length of the helix coil can be shortened and miniaturized more effectively.

In the preferred embodiment, the abovementioned cap 20 and the internal extension post 24 shaped integrally therewith can not be made of electric conducting material but shall be made of insulating plastic material. The higher the dielectric coefficient of the selected plastic material is, the more obvious effect of shortening the size of the antenna can be obtained.

In the present invention, because the coil is fitted in advance over the internal extension post shaped integrally with the cap, the verticality of the coil can be corrected during the entire production and assembling process of the antenna. The status that the pitch is affected also can be improved largely, the electric stability of the whole antenna becomes more desirable and the inferiority rate can be lowered during assembling in the factory. The more important thing is, the improved design of the present invention can shorten the overall length of the antenna for the communication equipments such as a mobile phone and the present invention is especially suitable for the trend of miniaturization of the antenna.

The above stated preferred embodiment is only for illustrating the present invention, it will be apparent to those skilled in this art that various modifications or changes can be made to the elements of the present invention without departing from the spirit and principle of this invention. And all such modifications and changes also fall within the scope of the appended claims and are intended to form part of this invention.

1. A helix antenna with a cap of high dielectric coefficient, said antenna includes said cap to be installed on the end portion of an insulating sleeve, a coil is positioned in said cap and said insulating sleeve, said helix antenna is characterized by:
said cap is made of high dielectric coefficient material with an internal extension post integrally shaped therein in matching with said coil by diameter in order that said coil is fitted over said internal extension post, a high dielectric coefficient thus is obtained inside said coil to thereby decrease wavelength correspondingly.

2. A helix antenna with a cap of high dielectric coefficient as claimed in claim 1, wherein,
said cap and said internal extension post are made of insulating plastic family material and are shaped integrally, said dielectric coefficient is decided accordingly.

3. A helix antenna with a cap of high dielectric coefficient as claimed in claim 1, wherein,
said internal extension post of said cap is extended from the center position of the inner top surface of said cap and shaped integrally therewith, the cross section of said internal extension post matches the size of the core diameter of and the shape of said coil; and then both are connected with each other in proper tightness.
